(19) United States
(12) Patent Application Publication
(10) Pub. No.: US 2024/0426268 A1
(43) Pub. Date: Dec. 26, 2024

(54) MARINE SUSPENSION ELECTRIC ENERGY GENERATION DEVICE

(71) Applicant: OFFCON GmbH, Kappeln (DE)

(72) Inventor: Harald Huebner, Kappeln (DE)

(21) Appl. No.: 18/682,996

(22) PCT Filed: Aug. 12, 2022
(86) PCT No.: PCT/DE2022/100598

§ 371 Date: Feb. 12, 2024

(30) Foreign Application Priority Data
Aug. 13, 2021 (DE) 10 2021 121 167.0

(51) Int. Cl. F03B 13/14; F15B 1/04

(52) U.S. Cl. CPC F03B 13/14; F15B 1/04; F05B 2240/931

(57) ABSTRACT

A marine suspension hydraulic electric energy generation device for generating electric energy from the suspension system of a suspended ship when moving through water, including—at least one suspended floating body (hull); —a chassis; —joints with damping cylinders; —a hydraulic system; —a hydraulic motor; —a generator; wherein—the stated elements are all constituent parts of a suspended ship; —the joints are installed with damping cylinders between the at least one suspended floating body (hull) and the chassis; —the hydraulic system is utilized as energy transmission element; —the conversion of hydraulic energy into mechanical energy takes place in the hydraulic motor; —the conversion of mechanical energy into electric energy takes place in the generator.

The invention relates to a marine suspension-hydraulic-electric energy generation device for generating electrical energy from the suspension system of a suspended ship when moving through water.

It comprises at least one suspended floating body (hull), a chassis, joints with damping cylinders, a hydraulic system, a hydraulic or pneumatic motor and a generator, wherein the elements mentioned are all components of a suspended ship, the joints with damping cylinders are installed between the at least one suspended floating body (hull) and the chassis, the hydraulic system and/or also pneumatic system is used as an energy transmission element, the conversion of hydraulic energy into mechanical energy takes place in the hydraulic motor and the conversion of mechanical energy into electrical energy takes place in the generator.

According to the invention, suspended ships are ships with a hydraulic or pneumatic suspension system in which at least one hull is connected to a chassis via a plurality of joints. This applies in particular to ships equipped with Nauti-Craft technology.

When traveling through the water, a relative movement occurs between the at least one hull and the chassis due to the inertia of the chassis when encountering waves (swell).

The kinetic energy from this movement is converted into pressure and heat energy in the damping cylinders by forcing hydraulic fluid in particular through an aperture (nozzle), for example. By dissipating the thermal energy, the relative movement between the at least one fuselage and the chassis is damped.

Various arrangements for generating energy from wave motion are known from prior art. There are wave power stations in the form of small hydroelectric power stations. In these, the energy of the ocean waves is used to generate electricity. Furthermore, the movement of floating or buoyant bodies excited by wave motion can also be used directly or hydraulically to generate electricity using various methods. The floating or buoyant bodies can either move relative to each other or rigidly to a reference point.

DE102008050238A1 discloses a wave power station for converting energy contained in the wave motion of water, comprising at least two floating bodies which can move relative to one another and which follow the wave motion of the water surface, wherein a rod element and at least one kinetic energy absorbing energy conversion unit are provided between the floating bodies, which are rotatably attached to the floating bodies via articulated connections, wherein the articulated connection associated with the rod element and the further articulated connection associated with the energy conversion unit on the floating body have a vertical spacing relative to one another.

Furthermore, a power station for converting mechanical primary energy into another form of energy in a power station, which operates particularly efficiently even with strongly fluctuating input power, comprising a power transmission element for receiving and passing on mechanical energy and a control system with a hydraulic control unit for setting a power transmission characteristic on the power transmission element, is known from DE102009004284A1.

WO2011/060183A2 discloses a system comprising a wave energy harvesting device and a watercraft (for example a ship) carrying an energy storage device (for example an array of batteries). The energy harvesting device is preferably also carried by the watercraft, but may be rigidly installed or carried by a separate watercraft. The watercraft is operated in an energy storage mode at an energy harvesting location exposed to wave activity, wherein the energy storage device stores energy from the wave activity harvested by the energy harvesting device. The watercraft is operated in an energy transport mode to transport the stored energy from the energy harvesting location to an energy delivery location (preferably onshore, but can also be offshore) that has a connection to an electrical power grid. At the energy release location, the watercraft is operated in an energy release mode in which the stored energy is converted into suitable alternating current which is fed into the electrical power grid.

Furthermore, a ship stabilizer for all seagoing vessels, whether at sea, river, sea or ocean, regardless of size, purpose, type of propulsion and hull shape, which converts ship movements caused by waves into energy (for example electrical) without hindering the task of the ship (for example transport), is known from DE102013018075A1. It is characterized by the flexible mounting with energy-converting damping (e.g. hydraulics, pneumatics, water) of any mass vibrating with the ship (e.g. ship cargo, persons, ship installations and superstructures or ballast).

DE 10 2018 007 648 A1 discloses a wave power plant. The wave power plant according to the invention consists of a substantially closed hollow body which is partially or completely in the water and moves due to the waves and a mass which is arranged in such a way that, when the hollow body moves, it causes a relative movement between the hollow body and the mass due to its inertia and means for converting the kinetic energy between the hollow body and the mass into electrical energy are arranged inside the hollow body.

A wave power plant in the form of a ship's pendulum is also known from CN 1 04 514 675 A. The invention comprises a ship's hull, a ship's pendulum, a hydraulic cylinder, a hydraulic motor and a hydraulic generator, whereby the influence of sea waves causes a relative movement between the ship's hull and the ship's pendulum.

The problems in the prior art are primarily that there are many wave power plants that are stationary and location-bound. The systems can only be installed at specific locations and are cost-intensive. In addition, the plants are exposed to the elemental forces of nature, which can lead to major damage to the plants, such as winter storms. These wave power plants were developed specifically for the purpose of converting/generating energy. This also includes systems based on the attenuator approach or the point absorber approach.

Wave power plants on watercraft such as ships are well known. The rolling motion of a watercraft, especially a ship, is used to generate electrical energy. For example, there are ship stabilizers which exclusively transmit the rolling motion of a ship to a hydraulic system via joints.

The present invention is based on the task of providing a device for suspended ships with which it is possible to use all degrees of freedom of a ship when traveling through the water to generate energy without noticeably changing the ship's structure for energy generation.

This task is solved with a marine suspension-hydraulic-electric energy generation device according to the main claim.

A marine suspension-hydraulic-electric energy generation device for generating electrical energy from the suspension system of a suspended ship when moving through the water comprises at least one suspended floating body (hull), a chassis, joints with damping cylinders, a hydraulic system, a hydraulic motor and a generator; wherein the stated elements are all constituent parts of a suspended ship, the joints with damping cylinders are installed between the at least one suspended floating body (hull) and the chassis, the hydraulic system is utilized as energy transmission element, the conversion of hydraulic energy into mechanical energy takes place in the hydraulic motor and the conversion of mechanical energy into electrical energy takes place in the generator, wherein the electrical energy is generated while the suspended ship is moving through the water, the potential energy contained in water waves and the kinetic energy of the moving ship are used as primary energy, all degrees of freedom in the movement of the ship are used for the generation of electrical energy by installing joints with damping cylinders between the at least one suspended ship (hull) and the chassis, and the electrical energy generated is fed directly into the ship's grid or is stored via an accumulator system or is fed into the system for uninterruptible power supply system.

The volume flow of hydraulic fluid can be fed directly into the hydraulically operated engine or stored temporarily in pressure accumulators. The advantage of storage in pressure accumulators enables a continuous energy call-off and more consistent electrical energy generation. When using a pressure accumulator, the turbine of the generator can be supplied with a volume flow that is independent of the working cycle of the damping cylinder.

The hydraulic motor can be operated with a variable volume flow. A novel aspect of the invention relates to the fact that the volume flow for operating the hydraulic motor may be regulated via a pressure accumulator and that the hydraulic motor may be operated with a variable volume flow.

The damping cylinders form the elements for generating the volume flow of hydraulic fluid. The volume flow is regulated via pressure accumulators and the hydraulic motor is operated with a variable volume flow.

The pressure is transmitted via the hydraulic fluid. A pressure relief valve can be used to protect against overload. Hydraulic energy is converted into mechanical energy via a hydraulic motor. The mechanical energy is converted into electrical energy in a generator.

A new feature of the invention is the ability to control the volume flow via pressure accumulators to operate the hydraulic motor and to operate the hydraulic motor with a variable volume flow.

Of course, operation is possible not only with a pure liquid, but also with a mixture of gas and liquid. Operation with a gaseous medium is also possible. In common usage, this is referred to as a pneumatic system. It should be clarified once again that in embodiments within the meaning of the scope of protection or the invention, pneumatic systems or mixed systems comprising hydraulics and pneumatics are also in accordance with the invention.

The hydraulic system and/or the hydraulic components can equivalently be designed as pneumatic components and/or a pneumatic system and/or a combination of hydraulic and pneumatic components. These variations are particular embodiments or variants.

The control of the device can be designed as a time-dependent control, a travel-dependent control, a pressure-dependent control, a speed-dependent control or a combination of different control types.

The level and type of the generated output voltage can be variable. Adaptation to the existing network structure is therefore possible.

The electrical energy/power generated can be supplied directly to the ship's grid or stored via an accumulator system. It is also possible to integrate it into the uninterruptible power supply system. The level and type of the generated output voltage is also variable and can be adapted to the existing grid structure. A novel aspect of the invention relates to the utilization of the energy absorbed when the ship is moving in rough seas to generate electrical energy, which is then made available to the ship for various consumers and stored.

The number of floating bodies is variable. The invention can be installed on one or more suspended floating body elements (hulls). This depends on the structure of the ship.

The potential energy contained in water waves and the kinetic energy of the moving ship are used as the primary energy. When traveling through the water, the hydraulically or pneumatically suspended floating bodies (hulls) rise and fall due to the effect of lifting forces when encountering waves (swell). The massive moment of inertia of the chassis causes a relative movement between the hulls and the chassis. This relative movement is transmitted to the hydraulic system via the damping cylinders installed between the hulls and the chassis. Work is thus performed via the stroke function of the damping cylinders.

According to the invention, the aim is not merely to convert this work into heat. As heat, this would remain unused and would have to be dissipated at great expense. Instead, the work is to be translated into mechanical work and converted into electrical energy in a generator connected via a shaft.

Instead of converting the hydraulic energy of the hydraulic fluid into heat by forcing it through an opening (nozzle), the energy is first converted from hydraulic energy into mechanical energy via a hydraulic motor. The mechanical energy is converted into electrical energy in a generator. The pressure is transmitted via the hydraulic fluid. A pressure relief valve is used to protect against overloading.

The damping cylinders form the elements for generating the volume flow. The volume flow is regulated via pressure accumulators and the hydraulic motor is operated with a variable volume flow.

The energy can be supplied directly to the hydraulically operated generator or stored in pressure accumulators and used to generate energy at a later time.

Another advantage of storage is that the energy can be called up continuously and electrical energy generation is more consistent.

The energy is converted dynamically and independently of location as the suspended ship travels through the water transporting people and goods. The electrical energy generated is available to the ship to cover its own energy requirements and thus reduce its ecological footprint.

1. A marine suspension hydraulic electric energy generation device for generating electric energy from the suspension system of a suspended ship when moving through water, comprising
at least one suspended floating body (hull);
a chassis;
joints with damping cylinders;
a hydraulic system;
a hydraulic motor;
a generator;
wherein
the stated elements are all constituent parts of a suspended ship;
the joints are installed with damping cylinders between the at least one suspended floating body (hull) and the chassis;
the hydraulic system is utilized as energy transmission element;
the conversion of hydraulic energy into mechanical energy takes place in the hydraulic motor;
the conversion of mechanical energy into electric energy takes place in the generator,
wherein
the electrical energy is generated while the suspended ship is moving through the water;
the potential energy contained in water waves and the kinetic energy of the moving ship are used as primary energy;
by installing joints with damping cylinders between the at least one suspended floating body (hull) and the chassis, all degrees of freedom in the movement of the vessel are used to generate electrical energy,
and
the electrical energy generated is fed directly into the ship's grid or stored via an accumulator system or fed into the uninterruptible power supply system.

2. A marine suspension hydraulic electric energy generation device according to claim 1, wherein the volume flow of the hydraulic fluid
is fed directly into the hydraulically operated motor
or
is temporarily stored in pressure accumulators.

3. A marine suspension hydraulic electric energy generation according to claim 1, wherein
the control is configured as
a time-dependent control;
path-dependent control;
pressure-dependent control;
speed-dependent control;
or
a combination of different types of control.

4. A marine suspension hydraulic electric energy generation device according to claim 1, wherein the amount and type of the generated output voltage is variable.

5. A marine suspension hydraulic electric energy generation device according to claim 1, wherein the amount and type of the generated output voltage is variable.

6. A marine suspension hydraulic electric energy generation device according to claim 1, wherein the hydraulic system and/or the hydraulic components are equivalently configured as pneumatic components and/or a pneumatic system and/or a combination of hydraulic and pneumatic components.
